(19) United States
(12) Patent Application Publication
(10) Pub. No.: US 2013/0001940 A1
(43) Pub. Date: Jan. 3, 2013

(54) COMPRESSIBLE PHOTONIC CRYSTAL-BASED AUTHENTICATION DEVICE

(75) Inventors: Andre Arsenault, Toronto (CA); Paul Chan, Toronto (CA)

(73) Assignee: Opalux Incorporated, Toronto, ON (CA)

(21) Appl. No.: 13/129,959

(22) PCT Filed: Nov. 17, 2009
(86) PCT No.: PCT/CA2009/001672

§ 371 Date: Aug. 16, 2012

Related U.S. Application Data
(60) Provisional application No. 61/115,682, filed on Nov. 18, 2008.

(51) Int. Cl. B32B 3/26; B42D 15/00; B32B 38/10; B32B 3/10; C08J 9/26

(52) U.S. Cl. 283/67; 428/221; 428/203; 428/304.4; 264/49; 264/45.1; 156/77

(57) ABSTRACT

A security and/or authentication device comprising: a compressible photonic crystal having an ordered array of voids, the photonic crystal having a reflection peak, wherein compression against at least a portion photonic crystal results in a decrease of intensity of the reflection peak in at least that portion.

### TECHNICAL FIELD

This disclosure relates to a compressible photonic crystal. In particular, this disclosure relates to a compressible photonic crystal-based authentication device.

### BACKGROUND

Photonic crystals (PCs) are materials having a periodic modulation in their refractive index (Yablonovitch, Phys. Rev. Lett., 58:2059, 1987), giving rise to a photonic band gap or stop gap, in which electromagnetic waves within a certain stop band wavelength range are totally reflected. The wavelengths of the stop band are dependent on the distance between the periodic modulations in the crystal. The reflected stop band wavelengths appear in the reflectance spectrum as a distinct reflectance peak known as a Bragg peak. The crystal may have a one-, two-, or three-dimensional periodic structure.

Because of the sensitivity of a PC, slight changes in the refractive index or lattice spacing results in detectable changes in the reflected light. This is particularly useful where the reflected light is in the visible range, allowing for changes in color if the refractive index or lattice spacing is modulated. By incorporating polymers into PC materials, they can be made responsive to mechanical force such as compression. An example of such an application is given by Arsenault et al. in PCT Patent Application No. WO2008098339, which is herein incorporated by reference in its entirety.

### SUMMARY

In some aspects, the present disclosure describes an authentication and/or security device based on a compressible photonic crystal. The compressible photonic crystal material has a certain characteristic reflection peak, due to the ordered lattice spacing in the material. Compression of the photonic crystal material, for example by the application of a mechanical force, causes a disruption of the internal structure of the material, resulting in a decrease in the intensity of the characteristic reflection peak. In some examples, the described devices could be used, for instance, as an anti-counterfeit device or brand-protection security seal.

In some aspects, there is provided a security and/or authentication device comprising: a compressible photonic crystal having an ordered array of voids, the photonic crystal having a reflection peak in a reflection wavelength range for light incident to an incident surface; wherein compression against at least a portion of the incident surface or an opposing surface causes a disruption of at least a portion of the ordered array of voids, the disruption resulting in a decrease of intensity of the reflection peak in at least that portion of the surface.

In some aspects, there is also provided a method of manufacturing a security and/or authentication device comprising: providing an ordered array of microparticles; infiltrating the ordered array of microparticles with a monomer or pre-polymer mixture; initializing cross-linking of the monomer or pre-polymer mixture to form a polymer; and removing the microparticles from the polymer to form an ordered array of voids in the polymer, thereby providing a photonic crystal; wherein the photonic crystal has a reflection peak in a reflection wavelength range for light incident to an incident surface, and wherein compression against at least a portion of the incident surface or an opposing surface causes a disruption of at least a portion of the ordered array of voids, the disruption resulting in a decrease of intensity of the reflection peak in the wavelength range in at least that portion of the surface.

In some aspects, there is also provided a use of the security and/or authentication device described above in currency, packaging, identification items, or documents of value.

In some aspects, there is also provided a currency item, packaging item, an identification item, and a document of value comprising the security and/or authentication device described above.

In some aspects, there is also provided a method of authentication using the security and/or authentication device described above comprising: providing the security and/or authentication device; compressing against the incident surface of the photonic crystal; and observing a decrease in intensity of the reflection peak in the reflection wavelength range.

### BRIEF DESCRIPTION OF THE DRAWINGS

Reference will now be made to the drawings, which show by way of example embodiments of the present disclosure, and in which:

FIG. 1 illustrates, in cross-section view, operation of an example photonic crystal material suitable for an example compressible photonic crystal-based authentication device;

FIG. 2 illustrates a cross-section of an example compressible photonic crystal-based authentication device;

FIG. 3 illustrates a top-down view of operation of an example compressible photonic crystal-based authentication device; and

FIG. 4 illustrates a top-down view of operation of another example compressible photonic crystal-based authentication device.

### DETAILED DESCRIPTION

The compressible photonic crystal material has an ordered lattice spacing. In an embodiment, the photonic crystal material may have an ordered array of voids and may be polymer-based, so as to be compressible. The photonic crystal may be fabricated so as to have a characteristic reflection peak from an incident surface when uncompressed. When the photonic crystal is compressed against the incident surface or an opposing surface, this compression causes a disruption in the ordered arrays of voids, causing the intensity of the reflection peak to decrease. Depending on the compressive force, the disruption can be small, causing only a small decrease in intensity of the reflection, or can be large, causing a large decrease in intensity of the reflection. If compressive force is high enough, the voids can completely collapse. In this case, the properties of the photonic crystal may be substantially similar to a non-porous polymer, meaning that the collapsed photonic crystal may no longer display any reflection peak—all or substantially all wavelengths of light may be transmitted through the collapsed photonic crystal.

Typically, compression of an area or a portion of the photonic crystal does not affect dimensions of the photonic crystal in a direction other than the compression direction, and the uncompressed areas of the photonic crystal may also be unaffected.

The reflection peak may be detected from the surface of the photonic crystal material. Where the reflection peak is within the visible spectrum, the reflection peak and its change in intensity due to compression may be seen by the naked eye. Compression of the photonic crystal may be through the application of a mechanical force on a viewable incident surface of the photonic crystal or on an opposing surface. Complete collapse of the photonic crystal structure may result in the intensity of the reflection peak being reduced to zero, such that the compressed photonic crystal is transparent or translucent.

The photonic crystal may be widely tailored to have a large range of reflection peak wavelengths, for example including wavelengths within the visible spectrum. The photonic crystal may also be fabricated to be susceptible to compression at different mechanical pressure, for example it may be fabricated so that it undergoes a complete collapse upon compression with light finger pressure. This tailoring of the photonic crystal may be through, for example, selection of materials used to manufacture the photonic crystal, through control of the size of its lattice spacing or voids, through control of the thickness and dimensions of the photonic crystal, or a combination of the above.

Such a compressible photonic crystal may be incorporated into a security and/or authentication device. The structure of such a device will be described in further detail below. In general, a security and/or authentication device based on a compressible photonic crystal may comprise a substrate layer and/or a protective coating layer. Such a device may be applied to a product, for example using an adhesive, or may be manufactured directly on the product.

Activation of the security device may be permanent or reversible. In the case of a permanent effect, compression may result in a permanent disruption to the ordered array of the photonic crystal. In the case of a reversible effect, compression may temporarily disrupt the ordered array, but this disruption may be at least partially reversed by applying a particular stimulus to the photonic crystal. Such a stimulus may include, for example, time, temperature, radiation, solvents, mechanical force, electrical energy, gases, or combinations thereof. Therefore, the security device incorporating such a photonic crystal may be engineered so that the device may be used as a one-time authentication feature, or conversely one that may be “reset” by the application of the particular stimulus, allowing the device to be used multiple times. In some examples, such a reset may be designed such that resetting of the device is possible only by the manufacturer. The photonic crystal may have fully reversible activation that allow the device to be used multiple times, or the reversibility may be only partial, such that even after the device has been reset, it may still indicate that it has already been activated at least once.

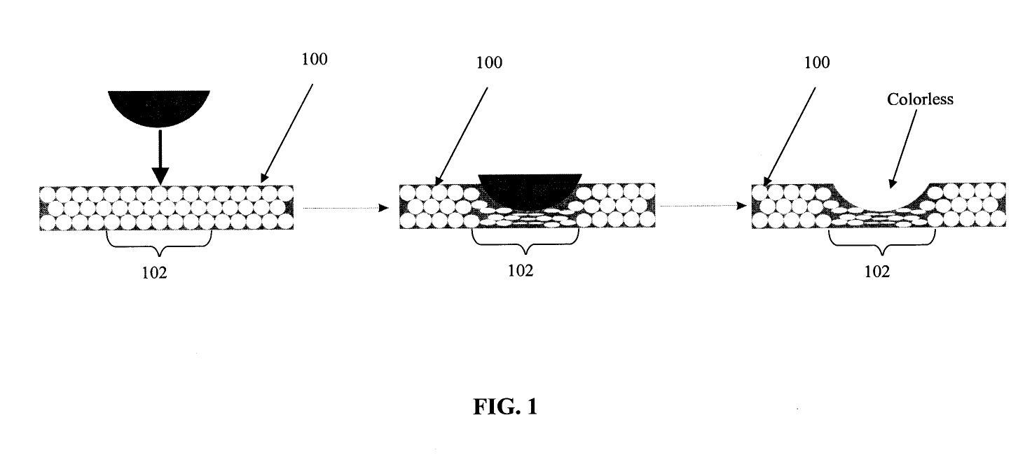

FIG. 1 illustrates the response of an example compressible photonic crystal material 100 suitable for use in a compressible photonic crystal-based security and/or authentication device when a certain area 102 of the material is compressed, for example by the application of mechanical pressure. In FIG. 1, a schematic cross-section of the photonic crystal material 100 is shown. Here, the pressure applied to a portion 102 of the surface of the photonic crystal collapses the ordered array of voids in the structure of the photonic crystal under that portion 102. In this example, the compression is large enough to completely collapse the structure of the photonic crystal 100 in the compressed portion 102, thus destroying the ability of the compressed portion 102 to display a reflection peak. Thus, in this example, compressed portion 102 may have substantially similar properties as a non-porous polymer. In the case where the uncompressed reflection peak was in the visible spectrum, compression may result in a shift from a visible reflected color to being colorless (i.e., no visible reflected color).

The photonic crystal may be provided as a thin film, for example with a thickness of less than or equal to about 100 micrometers. The voids in the photonic crystal may have an average diameter in the range of about 50 nm to about 1000 nm, more preferably in the range of about 180 nm to about 900 nm. The voids may be spherical and may be interconnected.

The photonic crystal may comprise a polymer. The polymer may be formed from a monomer or pre-polymer selected from the group including, for example: methacrylic acid esters, acrylic acid esters, polyisoprene, polybutadiene, polyurethane precursors, polyolefin precursors, polyethers, and mixtures thereof. The polymer may be a cross-linked polymer network.

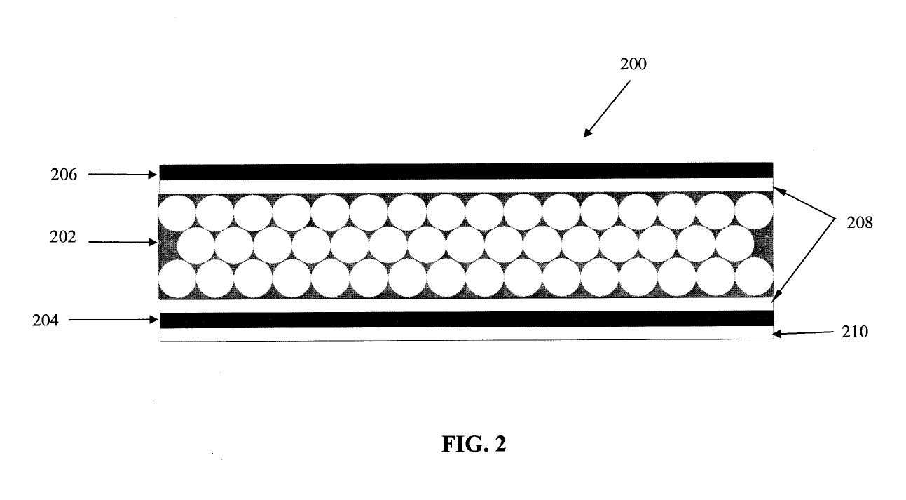

In FIG. 2, a cross-section of an example design schematic of the compressible photonic crystal-based security and/or authentication device 200 is shown. The device 200 includes a compressible photonic crystal 202, which in this example is supported on a substrate 204. The substrate 204 may be relatively flexible or relatively rigid. The substrate 204 may be clear, translucent, opaque, or colored, and may incorporate images, patterns, data content, or other such designs. Any such designs may be viewable through a compressed portion of the photonic crystal 202 when the device 200 is compressed. Suitable substrate materials may include, for example, plastic films, plastic sheets, metal foils, papers, glass, ceramics and combinations thereof. In some examples, the device 200 may include a protective top coating 206 or protective cover, which may include, for example, plastic films, lacquers, varnish, latex, glass or other suitable materials. The protective coating 206 may be relatively flexible or relatively rigid. The protective coating 206 may be transparent or translucent to allow the photonic crystal and/or the substrate to be viewable through the coating. In some examples, adhesives 208 may be included between the substrate 204 and the photonic crystal 202, and/or between the protective coating 206 and the photonic crystal 202, which may help to improve bonding characteristics. Where the device 200 is designed to be applied to an article, additional adhesives 210 may be applied to the back of the substrate 204 for attachment of the device 200 to an article. The additional adhesive 210 may be applied to the photonic crystal 202 directly where the device 200 does not include the substrate 204. The adhesives 208 and/or the additional adhesive 210 may be selected such that it does not penetrate into the array of voids in the photonic crystal 202, or such that any penetration is minimal and does not affect the ability of the photonic crystal 202 to display a reflection peak.

In one embodiment of the security and/or authentication device, a user would compress the security device, and observe a disappearance of the color in the compressed region. If the device is viewed using reflected light, the color will be that of the characteristic reflection peak. If the device is viewed using transmitted light, the color will be made up of those wavelengths complimentary to the characteristic reflection peak. In another embodiment, the security device could incorporate a colored background, so that a user applying a compression would perceive a change in color of the device in the compressed region.

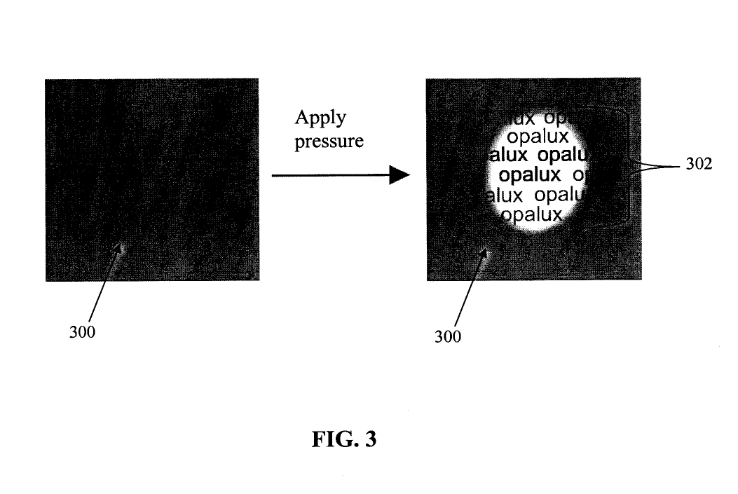

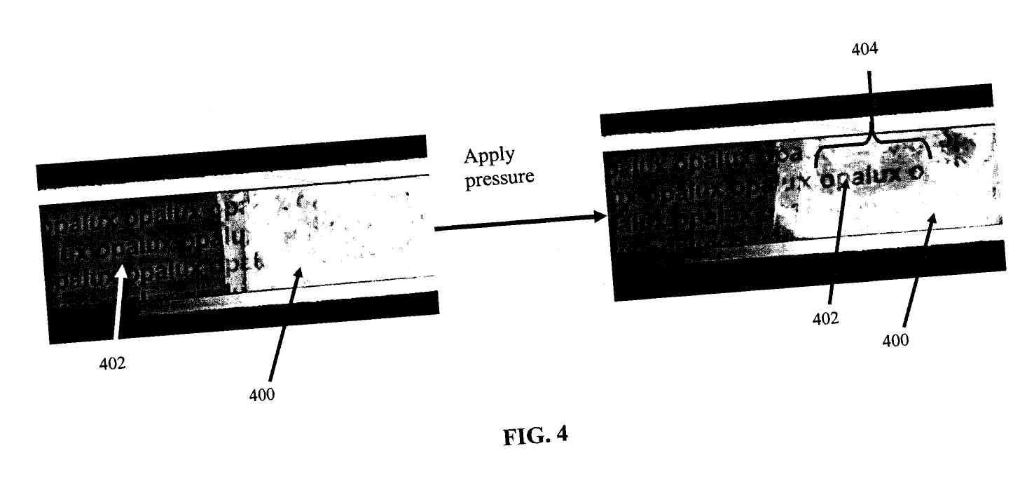

In another embodiment, the background may include an image such as a pattern, logo, picture, or data such as a barcode or alphanumeric code. Such a background may be provided on the substrate of the device, or may be provided on the surface of the article to which the device is applied. The user compressing the device would either see the image or data appear, or cause the already visible image or data to change appearance. For example, FIG. 3 is a top-view illustration of an example of this embodiment, where pressure is applied to the security device 300 and the compressed region 302 becomes colorless, at the same time revealing the latent pattern beneath the compressed region of the device. FIG. 4 shows another example of this embodiment, where the device 400 is provided over a patterned background 402. The example device 400 originally exhibits a visible reflected wavelength that is perceived as a green color, and after pressure is applied to a portion 404 of the device 400, the compressed portion 404 no longer exhibits the reflected wavelength and is perceived as colorless and transparent, revealing the patterned background 402 underneath the device 400.

The described devices may be used, for example, as anti-counterfeit or security devices and may be suitable for use in, for example: a) documents of value, including, for example, legal tender, bills of exchange, money orders, share certificates, bonds, stamps, land titles; b) cards and identification, including, for example, passports, birth certificates, driver licenses, visa documents, health cards, social security cards, national identity cards, work permits, citizenship documents, alien registration documents, credit cards, debit cards, gift cards, access passes, and membership cards; and c) product packaging and tagging, including, for example, that for over-the-counter and prescription drugs, medicines and pharmaceuticals, vaccines, vitamins, nutritional supplements, herbal formulations, herbicides, pesticides, apparel, accessories, watches, clothes, shoes, handbags, cosmetics, toys, jewelry, gems, precious metals, compact discs, videotapes, DVDs, computer software, video games, other media, technology products, batteries, airline parts, auto parts, small arms, wine, spirits, beer, cigarettes, cigars, books, sports equipment and memorabilia, collectibles, and antiques. Other applications may be suitable, including any application where authentication and/or security may be useful.

### Compositions

Examples of the described device may be based on a photonic crystal including a polymer having an ordered array of spherical voids. These spherical voids could be isolated, or could be connected to each other to form an interconnected array. The polymer can be selected from a broad range of classes including, for example, polyacrylates, polymethacrylates, polyisoprenes, polybutadienes, polyolefins, polyurethanes, and polyethers. The polymer may be cross-linked to form a cross-linked network.

In an embodiment, the polymer is formed from the polymerization of acrylic acid esters, which could be monofunctional or multifunctional. Monofunctional acrylic acid esters could include, for example, butoxyethyl acrylate, hydroxyethyl acrylate, 2-carboxyethyl acrylate, poly(2-carboxyethyl) acrylate, stearyl acrylate, lauryl acrylate, butyl acrylate, hexyl acrylate, 2-phenoxyethyl acrylate and mixtures thereof. Multifunctional acrylic acid esters could include, for example, diacrylates, which could include, for example, ethylene glycol diacrylate, poly(ethylene glycol) diacrylates, neopentyl glycol diacrylate, neopentyl glycol propoxylate (1 PO/OH) diacrylate, triacrylates, or polyacrylates. Other polymerizable acrylate monomers and prepolymers may be suitable, for example those available in research sizes from Sigma-Aldrich, as well as from Sartomer Company.

The fabrication of the device may be carried out in a manner similar to that described in PCT Patent Application No. WO2008098339.

For example, the manufacturing may include:

1) providing an ordered array of microparticles. In some examples, the microparticles may be necked, for example by treating the ordered array of microparticles with tetramethoxysilane vapor or silicon tetrachloride vapor. Necking may affect the structural properties of the manufactured material. Necking may also result in interconnected voids in the manufactured material. The microparticles may be, for example, silica or polymer microspheres. Polymer microspheres may include, for example, polystyrene microspheres, polymethacrylate microspheres, and mixtures thereof.

2) infiltrating the ordered array of microparticles with a monomer or pre-polymer mixture, which may include, for example, applying one of heat, agitation, vacuum, and pressure to the monomer or pre-polymer mixture. The monomer or pre-polymer mixture may include an initiator, such as a photoinitiator or a thermal initiator.

3) initializing cross-linking of the monomer or pre-polymer mixture to form a polymer. A suitable polymer may include, for example: polyacrylates, polymethacrylates, polyisoprenes, polybutadienes, polyolefins, polyurethanes, polyethers, and mixtures thereof.

4) removing the microparticles from the polymer to form an ordered array of voids in the polymer, thereby providing a photonic crystal, which may include etching the microparticles using, for example, one of hydrofluoric acid, sodium hydroxide, and polymer solvents.

Additional steps may include providing a substrate and/or protective coating for the photonic crystal, examples of which are described above.

Although the above disclosure provides specific examples, these are for the purpose of illustration only and are not intended to be limiting. Although an example of manufacturing is described, the device may be manufactured by other methods. Although the example of manufacturing is described as having steps in a given order, the steps may be carried out in a different order, or some steps may be omitted or modified. It will be understood by a person skilled in the art that variations and adjustments, including simple experimentation, may be possible within the scope of the disclosure. All references mentioned are hereby incorporated by reference in their entirety.

1-59. (canceled)

60. A security and/or authentication device comprising:
a compressible photonic crystal having an ordered array of voids, the photonic crystal having a reflection peak in a reflection wavelength range for light incident to an incident surface;
wherein compression against at least a portion of the incident surface or an opposing surface causes a disruption of at least a portion of the ordered array of voids, the disruption resulting in a decrease of intensity of the reflection peak in at least that portion of the surface.

61. The security and/or authentication device of claim 60 wherein the disruption of the ordered array results in collapse of the voids, resulting in at least that portion of the photonic crystal having the intensity of the reflection peak decreased to zero.

62. The security and/or authentication device of claim 60 wherein dimensions of the device in directions other than direction of the compression are substantially unaffected by the compression.

63. The security and/or authentication device of claim 60 wherein a portion of the device that is free of the compression is unaffected by the compression.

64. The security and/or authentication device of claim 60 wherein the photonic crystal is a thin film.

65. The security and/or authentication device of claim 60 further comprising a substrate at the opposing surface of the photonic crystal.

66. The security and/or authentication device of claim 65 wherein the substrate is a flexible substrate.

67. The security and/or authentication device of claim 65 wherein the substrate includes at least one of: an underlying pattern, background color, image, pattern, design or data content, that is viewable or that has a different appearance once the device is compressed.

68. The security and/or authentication device of claim 60 further comprising a transparent or translucent protective coating over the incident surface of the photonic crystal.

69. The security and/or authentication device of claim 60 wherein the compression causes a permanent disruption of the ordered array.

70. The security and/or authentication device of claim 60 wherein the compression causes a reversible disruption of the ordered array.

71. The security and/or authentication device of claim 70 wherein the reversible disruption of the ordered array is at least partially reversible through the application of a stimulus.

72. The security and/or authentication device of claim 71 wherein the stimulus is selected from the group consisting of: time, temperature, radiation, solvents, mechanical force, electrical energy, gases, and combinations thereof.

73. The security and/or authentication device of claim 60 wherein the photonic crystal is a polymer having an ordered array of voids.

74. A method of manufacturing a security and/or authentication device comprising:
providing an ordered array of microparticles;
infiltrating the ordered array of microparticles with a monomer or pre-polymer mixture;
initializing cross-linking of the monomer or pre-polymer mixture to form a polymer; and
removing the microparticles from the polymer to form an ordered array of voids in the polymer, thereby providing a photonic crystal;
wherein the photonic crystal has a reflection peak in a reflection wavelength range for light incident to an incident surface, and wherein compression against at least a portion of the incident surface or an opposing surface causes a disruption of at least a portion of the ordered array of voids, the disruption resulting in a decrease of intensity of the reflection peak in the wavelength range in at least that portion of the surface.

75. The method of claim 74 further comprising providing at least one of a protective coating and a substrate for the photonic crystal.

76. A use of the security and/or authentication device of claim 60 in at least one of: currency, packaging, identification items, or documents of value.

77. An authenticable item comprising the security and/or authentication device of claim 60, the authenticable item being one of: a currency item, a packaging item, an identification item, or a document of value.

78. A method of authentication using the security and/or authentication device of claim 60 comprising:
providing the security and/or authentication device;
compressing against the incident surface of the photonic crystal; and
observing a decrease in intensity of the reflection peak in the reflection wavelength range.

79. The method of claim 78 wherein the photonic crystal is provided on a substrate and observing comprises observing an appearance or change of at least one of: a background color, pattern, image, design or data content provided on the substrate.
